(19) United States
(12) Patent Application Publication
(10) Pub. No.: US 2007/0211972 A1
(43) Pub. Date: Sep. 13, 2007

(54) Ball Element for Two-Part Ball Pivots and Process for Manufacturing Same

(76) Inventors: Jochen Kruse, Osnabrueck (DE); Dirk Adamczyk, Lemfoerde (DE); Reinhard Stoeterau, Saint-Just/Saint-Rambert (FR); Jean-Paul Castanet, Monistrol sur Loire (FR)

Correspondence Address: MCGLEW & TUTTLE, PC, P.O. BOX 9227, SCARBOROUGH STATION, SCARBOROUGH, NY, 10510-9227, US

(21) Appl. No.: 11/568,640

(22) PCT Filed: May 2, 2005
(86) PCT No.: PCT/DE05/00823

§ 371 Date: May 2, 2007

(30) Foreign Application Priority Data
Apr. 5, 2004 (DE) 102004 022248.7

(51) Int. Cl. B21K 1/02; F16C 17/00

(52) U.S. Cl. 384/206; 29/898.052

(57) ABSTRACT

A process is provided for manufacturing balls, especially for ball and socket joints, as well as to a ball element for two-part ball pivots. The microalloyed carbon-manganese steel balls are manufactured by cold extrusion and subsequent grinding. Annealing can thus be completely eliminated, as a result of which a less expensive material can be used. The process makes possible a manufacture of balls especially for two-part ball pivots in a simpler manner and at a lower cost, and the surface finish and the material quality as well as the strength and the wear resistance are at the same time preserved or increased. As a result, the effort needed to manufacture the balls is reduced, and, moreover, the problem of the impact marks often developing on the ball surfaces during tempering is eliminated.

### CROSS REFERENCE TO RELATED APPLICATIONS

This application is a United States National Phase application of International Application PCT/DE2005/000823 and claims the benefit of priority under 35 U.S.C. § 119 of German Patent Application DE 10 2004 002 248.7 filed May 4, 2004, the entire contents of which are incorporated herein by reference.

### FIELD OF THE INVENTION

The present invention pertains to a process for manufacturing balls or ball segments, especially for ball and socket joints and furthermore pertains to a ball element for two-part ball pivots.

### BACKGROUND OF THE INVENTION

Two-part ball pivots usually comprise a pivot element as well as a separate ball holed to receive the pivot element. It is known in this connection that balls for two-part ball pivots, more precisely, ball elements, for example, holed balls or ball segments, can be manufactured by cold extrusion. Tempering steel is usually used in the state of the art to manufacture the balls for two-part ball pivots. Tempering of the balls is first carried out now after the cold extrusion of the balls. The balls are quenched in connection with the tempering process by pouring the balls in the hot or soft state into the quenching medium from the tempering furnace.

However, the still soft balls collide with one another and the walls of the quenching container while they are being poured into the quenching medium, as a result of which undesired impact marks develop on the ball surfaces. These impact marks must be removed again in a complicated manner in subsequent process steps, for example, by grinding the ball surfaces. However, as much material as corresponds to the depth of the impact marks must essentially be removed from the entire ball surface. A considerable volume of material is to be removed, which considerably increases the time needed for grinding, on the one hand, and, on the other hand, leads to rapid wear of the grinding tools. In addition, the volume of material to be ground off must be taken into account in advance in the form of an oversize during the manufacture of the balls, as a result of which additional material costs arise.

Another drawback of prior-art manufacturing processes for such balls is that tempering steel must be used for this purpose according to the state of the art. However, this tempering steel is more expensive than other steels, which is linked, among other things, with the fact that the tempering steel must be drawn in a drawing shop and annealed into spherical cementite (annealing into spherical cementite) to achieve the desired material structure.

In addition, the balls manufactured from tempering steel must, of course, be subjected to the corresponding tempering process after extrusion in order for the balls manufactured from the tempering steel to achieve the desired, intended hardness values and strength properties of the tempering steel. However, all this is complicated and therefore leads to high manufacturing costs for the balls.

### SUMMARY OF THE INVENTION

Against this background, the object of the present invention is to provide balls especially for two-part ball pivots and a process for manufacturing balls, with which balls and with which process the drawbacks of the state of the art can be overcome.

The balls shall be able to be manufactured, in particular, in a simple manner and at a low cost. In particular, the problem of the development of impact marks and hence the need to subsequently eliminate the impact marks must be done away with. However, the high material and surface finish of the balls that is obtained with the prior-art processes as well as the desired high strength of the balls shall likewise be achieved and retained.

The process according to the present invention for manufacturing balls comprises the process steps described below.

In a manner that is known per se, a bar section or wire section is first manufactured from a blank in a first process step. However, according to the invention, a blank that consists of microalloyed carbon-manganese steel is used. Any carbon-manganese steel with microalloying elements that was hot-rolled after melting and has a fine-grained ferritic-pearlitic structure is suitable, in principle.

The section is subsequently pickled (e.g., in a strong mineral acid) in order to remove oxide coatings and to obtain a metallically pure surface on the section for the subsequent operations.

The bar section or wire section is then formed in an additional process step such that the desired ball form is formed.

The grinding of the ball surface to the intended size and the intended shape is finally performed in another process step.

The process according to the present invention is extremely advantageous in several respects. First, a microalloyed carbon-manganese steel is used to manufacture the balls instead of the tempering steel known from the state of the art. In particular, the microalloyed carbon-manganese steel does not need to be tempered, but, as was found, it attains an excellent strength and hardness because of the cold forming, which takes place in the process step in which the ball is extruded from the bar or wire section.

Since the process step of tempering, which is always necessary according to the state of the art for manufacturing the balls, can be completely eliminated as a consequence, the effort associated with tempering as well as the corresponding costs are eliminated as well. In particular, however, the problem of the undesired impact marks on the ball surfaces, which develop when the hot and soft balls are poured from the tempering furnace into the quenching medium, is thus completely eliminated as well.

In other words, this means, besides, that the balls can be dimensioned considerably closer to the final dimensions already during the cold extrusion, because it is no longer necessary, as it was before in the state of the art, to take into account the removal of a considerable amount of material during the grinding of the balls, which was necessary there to remove the impact marks. The blank used can be utilized in this manner more completely, on the one hand, as a result of which material costs can already be reduced. On the other hand. the time needed for the subsequent grinding is considerably reduced, because considerably less material needs to be removed. Last but not least, the wear on the grinding tools as well as the amount of grits and grinds generated are thus substantially reduced, which likewise leads to cost savings and is favorable for the environmental friendliness of the manufacturing process.

As was found, the balls cold-extruded from microalloyed carbon-manganese steel even have a substantially greater hardness after extrusion because of the cold forming as well as because of the described special properties of the microalloyed steel than the tempered balls known from the state of the art.

This greater hardness improves the grindability of the balls, on the one hand, and reduces the necessary grinding time. On the other hand, an even smaller number of impact marks will thus be formed on the ball surfaces during the handling of the balls in the entire manufacturing process and especially also after the grinding. This is advantageous, because a ball shape that comes as close to the ideal spherical surface as possible and is free from impact marks leads to especially smooth-running and low-wear ball and socket joints, which show the slightest possible slip effects during the motion of the ball in the bearing shell.

According to preferred embodiments of the present invention, the sections are subjected after pickling to a drawing process in another process step, or annealing and drawing of the sections into spherical cementite (annealing into spherical cementite) takes place after pickling. Strain-hardening of the material is thus achieved already before the final cold extrusion, as a result of which the strength of the balls subsequently obtained increases further.

According to another, likewise preferred embodiment of the present invention, the wire or bar sections are phosphated and/or coated with a dry lubricant before drawing or before the GKZ (annealing into spherical cementite) treatment. Since high compressive strains develop between the workpiece and the tool during cold extrusion, it is usually necessary to take measures by which cold welding is prevented from occurring between the tool and the workpiece. This is achieved here by applying a carrier or phosphate layer on the wire or bar sections. A dry lubricant layer, which has sufficient pressure resistance during the cold extrusion and thus prevents metallic contact between the workpiece and the tool, is in turn applied to the carrier layer. For example, graphite, molybdenum sulfide, special soaps or waxes may be used as pressure-resistant, solid lubricants.

According to a preferred embodiment of the present invention, nitrocarburizing of the balls is carried out in another process step after the grinding of the ball surface.

Nitrocarburizing leads to improvements in corrosion resistance and wear resistance, especially in case of surface adhesion between the ball and the bearing shell. Furthermore, a nitrocarburized surface has a reduced coefficient of friction. This us due to the so-called white layer, which is produced on the ball surface, has an especially high resistance and a thickness of only a few hundredths of one millimeter. Furthermore, nitrocarburizing is a comparatively environmentally friendly process and forms an advantageous alternative to, e.g., layers deposited by electroplating. Nitrocarburizing is preferably carried out in a salt bath.

According to another preferred embodiment of the present invention, the balls are polished or ground again and subsequently polished in another process step after grinding and after nitrocarburizing. The corrosion resistance and the wear resistance of the ball surface is further increased and the coefficient of friction is further reduced as a result.

According to another, likewise preferred embodiment of the present invention, the carbon-manganese steel has a microalloying element to accelerate the nitrogen absorption during nitriding or nitrocarburizing. The microalloying element is especially preferably vanadium.

Due to the use especially of vanadium as a microalloying element, the nitrogen absorption accelerates during nitriding. Higher hardness values and greater effective hardening depths of the white layer can be achieved in this manner with unchanged nitriding times, as a result of which the corrosion behavior is, besides, improved further. As an alternative, the same advantageous properties of the white layer can be obtained with shorter process or nitriding times as in the case of a tempering steel. Experiments have revealed, for example, that the salt bath process time can thus be reduced from 90 minutes by 33% to 60 minutes.

On the whole, the optimized nitriding process and the shortening of the nitriding times lead to a further cost advantage of the process according to the present invention compared to the manufacturing processes known from the state of the art for manufacturing balls from tempering steels.

In addition, the present invention pertains to a ball element, especially for two-part ball pivots. A two-part ball pivot is composed in the known manner essentially of a pivot element and a holed ball element. However, the ball element is characterized according to the present invention in that it consists of a tempering-free carbon-manganese steel with microalloying elements.

The microalloyed carbon-manganese steel requires no tempering process, but it has excellent strength and hardness already because of the cold forming due to the extrusion. As was already described in the introduction, tempering, which is necessary according to the state of the art to manufacture the balls, can thus be eliminated, as a result of which the corresponding effort as well as the costs associated therewith will be eliminated as well. In addition, the problem of the undesired impact marks on the ball surfaces is solved, because the pouring of the hot and soft balls from the tempering furnace into the quenching medium, which is problematic in this respect, is completely eliminated. The microalloyed carbon-manganese steel according to preferred embodiments of the present invention is drawn, subjected to annealing into spherical cementite or coated, especially phosphated.

According to a preferred embodiment of the present invention, the ball element is nitrocarburized. The corrosion resistance and the wear resistance as well as the friction behavior of the ball element are improved hereby, especially concerning the adhesion between the ball and the bearing shell, which occurs in ball and socket joints because of the low angular velocities.

According to other, preferred embodiments of the present invention, the ball element is ground and/or polished, as a result of which balls of especially high quality and long service life for low-friction ball and socket joints are obtained.

According to other, likewise preferred embodiments of the present invention, the microalloying elements contain vanadium.

As a result, the nitrided or nitrocarburized balls have an especially hard and especially thick white layer, as a result of which the corrosion behavior is improved, in particular.

The present invention will be explained below on the basis of drawings showing only one exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is the polished section of the structure of a tempering steel for balls according to the state of the art;

FIG. 2 is the structure of a microalloyed carbon-manganese steel for balls according to the present invention in a view corresponding to FIG. 1;

FIG. 3 is a logarithmic plot of the cumulative fracture probability P as a function of the tensile strength σ in MPa according to Weibull;

FIG. 4 is a linear bar chart showing a comparison of the strengths of balls manufactured according to the present invention with tempered balls according to the state of the art;

FIG. 5 is a graph showing curves representing the properties of the white layer produced by nitrocarburizing in balls manufactured according to the present invention compared to tempered balls according to the state of the art; and

FIG. 6A is a side view of a ball manufactured according to the present invention for a two-part ball pivot; and

FIG. 6B is a top view of a ball manufactured according to the present invention for a two-part ball pivot.

### DESCRIPTION OF THE PREFERRED EMBODIMENTS

Referring to the drawings in particular, FIG. 1 shows the greatly enlarged polished section of the ferritic-pearlitic structure of a tempering steel for balls according to the state of the art. This is specifically the structure of a hot-rolled standard tempering steel with the designation 41Cr4.

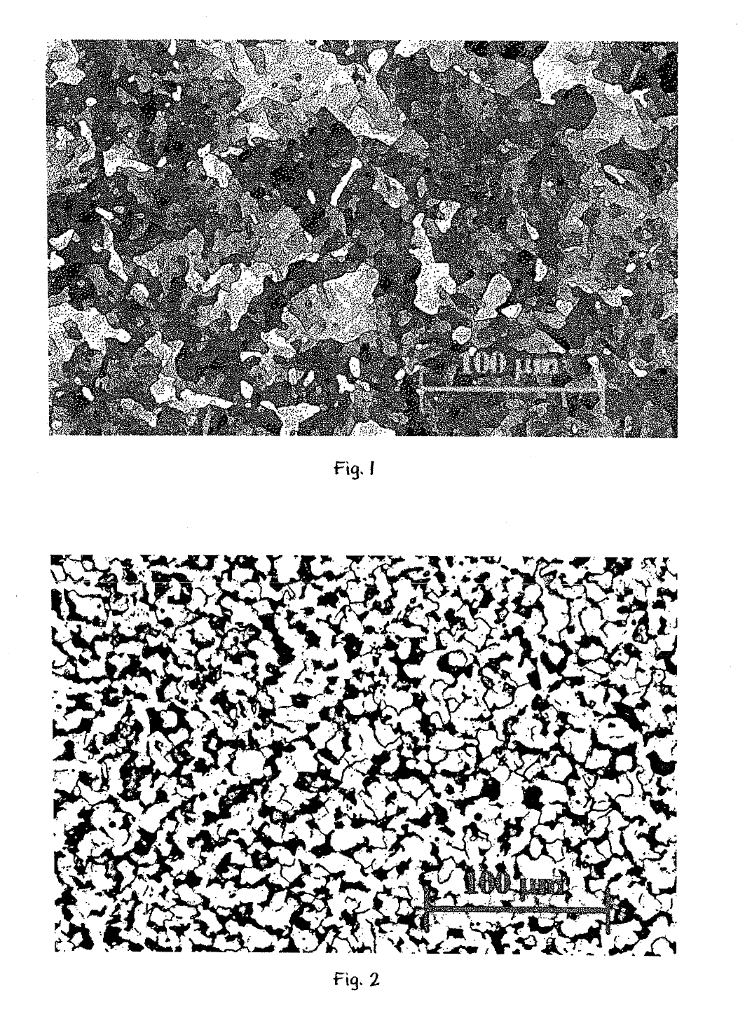

FIG. 2 shows the polished section of the likewise ferritic-pearlitic structure of a microalloyed carbon-manganese steel for balls according to the present invention at the same enlargement as the polished section of the tempering steel according to FIG. 1.

This is the microalloyed steel with the designation 35 V1 or C-Mn-V, which is likewise hot-rolled during manufacture.

This steel has the following alloying elements (all data in weight percent):
0.35% C
0.20% Si
0.75% Mn
0.02% P
0.02% S
0.20% Cr
0.15% Ni
0.20% Cu
0.10% V
0.02% Al
0.01% N.

The comparison of FIGS. 1 and 2 shows the much finer structure of the microalloyed steel according to FIG. 2 compared to the usual tempering steel according to FIG. 1. The fine structure of the microalloyed steel according to FIG. 2 leads, in particular, to an especially good cold deformability of the microalloyed steel, which is advantageous for producing the balls according to the present invention by cold extrusion.

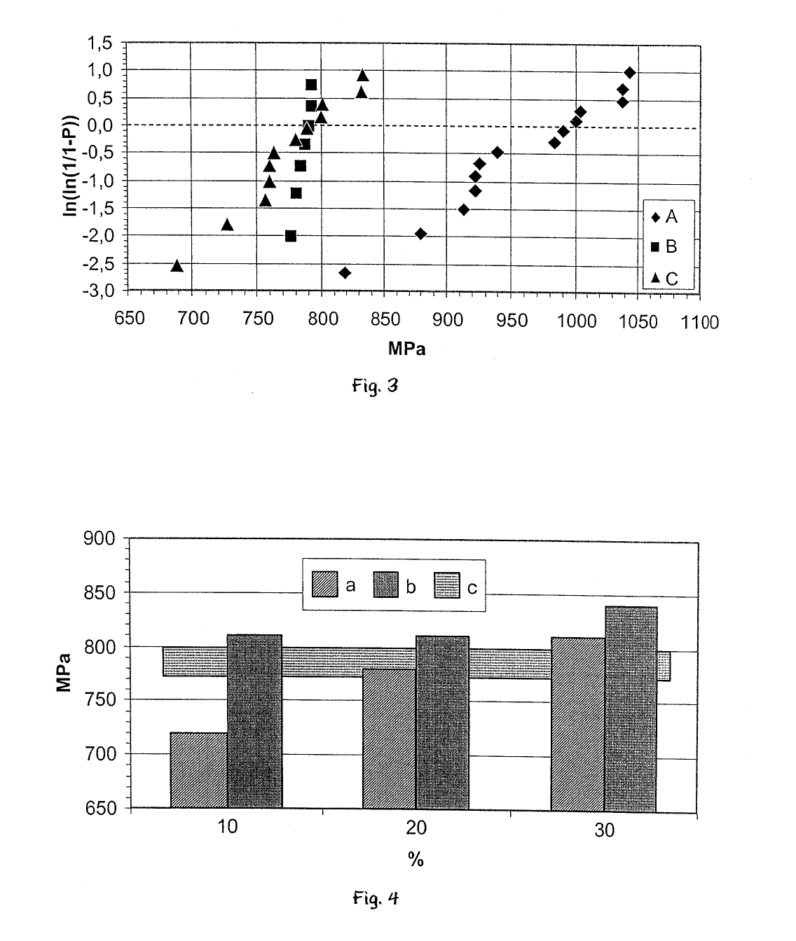

FIG. 3 shows the strengths of different cold-extruded balls calculated from hardness measurements. The diagram shows the cumulative fracture probability P plotted on a double-logarithmic scale on the vertical axis in the form of a Weibull distribution against the tensile strength σ in MPa plotted on the right-hand abscissa axis. The tensile strength according to DIN 50150 was calculated from measured hardness values, the hardness values having been measured at different points of the balls.

The diagram according to FIG. 3 contains measured values for three different types of balls. The diamond-shaped test points designated by letter A in the legend pertain to the ball manufactured according to the present invention by cold extrusion from microalloyed carbon-manganese steel. The square test points designated by letter B in the legend in FIG. 3 pertain to balls manufactured from a tempering steel according to the state of the art. This steel is specifically an ordinary tempering steel with the designation 38 MnB5. The triangular test points designated by letter C in the legend in FIG. 3 pertain, in turn, to the balls according to the present invention made of microalloyed carbon-manganese steel, the triangular test points pertaining to the balls according to the present invention after nitrocarburizing.

It is recognized from FIG. 3 that the strength of the balls according to the present invention, made of microalloyed carbon-manganese steel (diamonds) is quite substantially higher than the strength of the tempering steel according to the state of the art (squares). This greater hardness is advantageous, among other things, during the machining of the balls by grinding, because the grinding time can be markedly reduced in this manner, as a result of which costs are saved.

On the other hand, an especially small number of impact marks will be formed on the ball surfaces because of the greater hardness during the handling of the balls during and after the manufacturing process. Balls for ball and socket joints without impact marks are especially advantageous because it is thus possible to obtain especially smooth-running and low-wear ball and socket joints with long service life, which have an especially low tendency towards stick-slip effect in operation during the motion of the ball in the bearing shell.

Finally, the greater hardness of the balls according to the present invention, made of microalloyed carbon-manganese steel, is also advantageous because the corrosion resistance and the friction behavior during the use of the balls in ball and socket joints are thus improved as well.

In addition, FIG. 3 shows the strength of the balls according to the present invention made of microalloyed carbon-manganese steel, which is plotted in the form of triangular test points, after the balls according to the present invention have been subjected to nitrocarburizing. It is recognized from the intersections of the imaginary Weibull lines (the straight lines defined by a group of test points each) with the y axis at zero that the balls according to the present invention from microalloyed carbon-manganese steel have strength values (triangular test points) even after nitrocarburizing that are just as high as that of the balls made of tempering steel (square test points).

Even though it could actually be expected that recovery of the structure of the balls, which underwent strain-hardening during extrusion, should occur on the ball surface because of the temperatures reaching values close to 600° C. which are used during nitrocarburizing and that a great decrease in the high strengths reached due to the extrusion should occur in connection with this, it was surprisingly found that the high strength of the balls according to the present invention is advantageously preserved nearly completely even after the nitrocarburizing. This can be thought to be due to the fact that because of the microalloying elements contained in the material of the balls according to the present invention, complete recovery of the strain-hardened structure does not take place under the conditions of the nitrocarburizing process.

The rises of the Weibull lines of the balls made of microalloyed carbon-manganese steel according to the present invention (triangles and squares), which can be recognized from FIG. 3 and are smaller than those in case of the tempering steel, suggest only that because of the different degrees of working at different points of the ball, there are different degrees of strain-hardening of the material, because the measured values shown were determined over the entire cross section of the ball. As was shown by experiments, this has no adverse effects concerning the excellent suitability of the balls according to the present invention for use in ball and socket joints.

FIG. 4 shows, in turn, the tensile strengths of different balls according to the present invention made of another microalloyed carbon-manganese steel with the designation 10 MnSi7 (right-hand dotted vertical bars), which were determined from the hardness according to DIN 50150, as well as the tensile strength of the wires from which the balls in question were manufactured (left-hand shaded bars). In addition, the diagram in FIG. 4 shows again the strength values of a tempering steel according to the state of the art (vertical bars) for comparison. The percentages on the right-hand abscissa axis indicate the dimension to which the wire from which the balls were extruded was drawn before extrusion. The wire was drawn after hot rolling as well as before the extrusion of the balls.

It is recognized that the nontempering balls made of the microalloyed carbon-manganese steel (right-hand dotted bars) consistently have a higher strength than the balls made of the tempering steel (horizontal bar), and this largely independently from the degree of drawing of the wire and the strength of the wire or the starting material that is associated therewith (left-hand shaded bars).

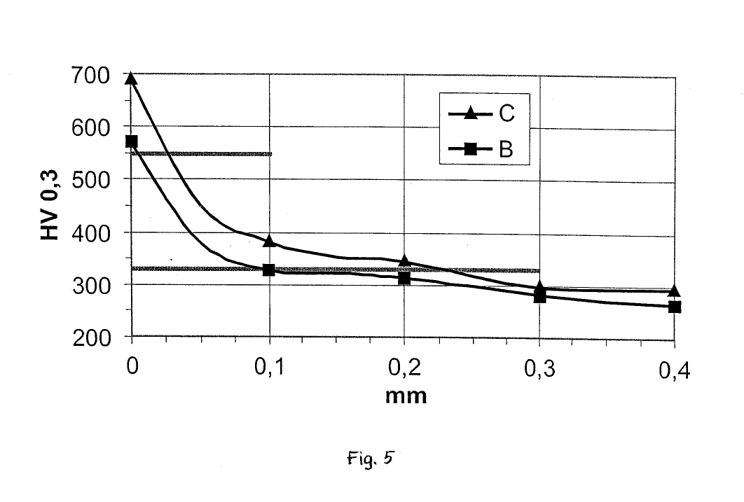

FIG. 5 shows the hardness profile of a ball manufactured according to the present invention from a nontempering, microalloyed carbon-manganese steel (35V1) after nitrocarburizing, the measured hardness values being plotted over the depth under the ball surface.

According to the legend in FIG. 5, letter C again designates the measured values for the carbon-manganese steel (triangular test points). The corresponding measured hardness values of a ball from a usual tempering steel according to the state of the art are shown for comparison in the diagram in FIG. 5, see letter B again in the legend in FIG. 5 (square test points).

It is recognized that the balls made of microalloyed carbon-manganese steel according to the present invention (triangular test points) still have a greater hardness even after nitrocarburizing than corresponding balls made of tempering steel according to the state of the art (square test points). As was already explained above, the greater hardness is advantageous, among other things, for the especially good wear resistance of the balls according to the present invention as well as the time- and cost-saving, improved processability of the balls during grinding.

In addition, the desired values specified by the design for the hardness on the surface and at a depth of 0.2 mm are shown in FIG. 5 for comparison for balls for ball and socket joints, cf. the two horizontal bars in the diagram in FIG. 5. It is seen that the white layer of the balls according to the present invention (triangular test points) meets or even exceeds the required hardness values specified.

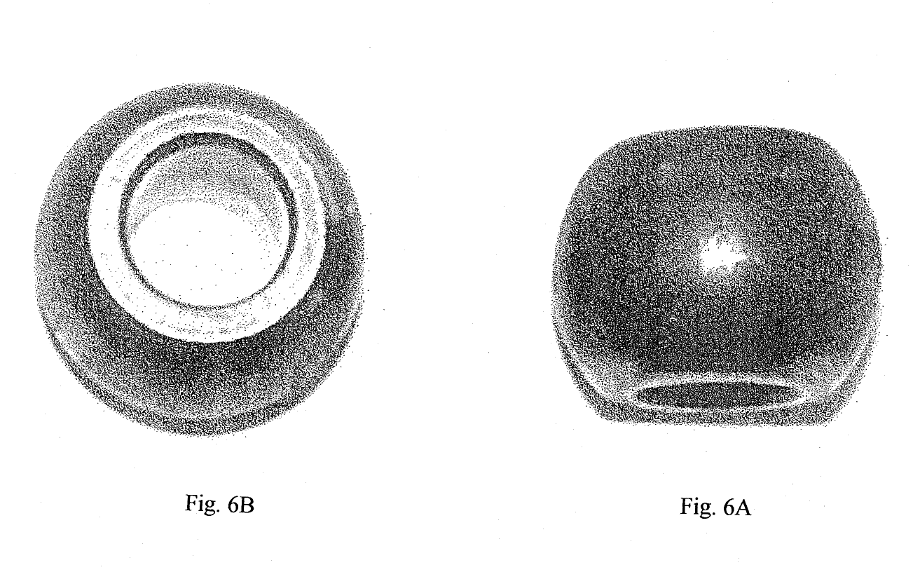

Finally, FIG. 6 shows two different views of a ball manufactured according to the present invention from tempering-free, microalloyed carbon-manganese steel for a two-part ball pivot, which is holed to receive the pivot element. It is recognized that the balls can be manufactured by the process according to the present invention without problems, especially without cracks as well as with perfect surface finish.

It thus becomes clear as a result that it is now possible thanks to the present invention to manufacture balls especially for two-part ball pivots in a simpler manner and less expensively than before, but the surface finish and the material quality as well as the required strength and wear resistance of the balls can be maintained or even exceeded at the same time. Due, among other things, to the elimination of the hitherto necessary tempering, considerable cost savings are achieved, on the one hand, and, on the other hand, the problem of the impact marks often formed on the ball surfaces during tempering is eliminated.

Thus, the present invention makes a substantial contribution to the especially economical production of high-quality balls, especially for ball and socket joints, wheel suspensions, stabilizers as well as for comparable intended applications. While specific embodiments of the invention have been shown and described in detail to illustrate the application of the principles of the invention, it will be understood that the invention may be embodied otherwise without departing from such principles.

1. A process for manufacturing balls or ball segments, for ball and socket joints, the process comprising the steps of:
a) preparing a bar section or wire section from a hot-rolled blank from microalloyed carbon-manganese steel;
b) pickling the bar section;
c) cold extruding the bar section into a ball or ball segment; and
d) grinding the ball surface of the ball or ball segment.

2. A process in accordance with claim 1, wherein at least one drawing operation is carried out in another process step after the process step b of pickling.

3. A process in accordance with claim 1, wherein drawing of the section and annealing into spherical cementite is carried out in another process step after process step b of pickling.

4. A process in accordance with claim 2, wherein drawing of the section and annealing into spherical cementite is carried out in another process step after process step b of pickling wherein the section is phosphated and/or coated with a dry lubricant before drawing or during annealing into spherical cementite.

5. A process in accordance with claim 1, wherein nitrocarburizing of the balls or ball segments is carried out in another process step e after process step d of grinding.

6. A process in accordance with claim 5, characterized in that wherein the nitrocarburizing is carried out in process step e in a salt bath.

7. A process in accordance with claim 6, wherein the balls or ball segments are ground and/or polished in another process step f after process step d (grinding) or e (nitrocarburizing).

8. A process in accordance with one of the claim 1, wherein the carbon-manganese steel contains a microalloying element to accelerate the nitrogen absorption during nitriding or nitrocarburizing.

9. A process in accordance with claim 8, wherein the additional microalloying element is vanadium.

10. A ball element connected to a ball pivot or, for a two-part ball pivots, said ball element of comprising a nontempering carbon-manganese steel with microalloying elements.

11. A ball element in accordance with claim 10, wherein the ball element is manufactured from a drawn wire.

12. A ball element in accordance with claim 10 wherein the ball element consists of a wire annealed into spherical cementite.

13. A ball element in accordance with claim 10, wherein the ball element consists of a coated phosphated wire.

14. A ball element in accordance with claim 10, wherein the ball element is nitrocarburized.

15. A ball element in accordance with claim 10 wherein the ball element is ground.

16. A ball element in accordance claim 10 wherein the ball element is polished.

17. A ball element in accordance with claim 10 wherein the microalloying elements contain vanadium.
